(19) United States
(12) Patent Application Publication
(10) Pub. No.: US 2018/0237008 A1
(43) Pub. Date: Aug. 23, 2018

(54) CONTROL DEVICE FOR VEHICLE

(71) Applicant: Toyota Jidosha Kabushiki Kaisha, Toyota-shi Aichi-ken (JP)

(72) Inventor: Takeshi Matsumura, Numazu-shi Shizuoka-ken (JP)

(21) Appl. No.: 15/899,945

(22) Filed: Feb. 20, 2018

(30) Foreign Application Priority Data
Feb. 21, 2017 (JP) 2017-030206

(51) Int. Cl. B60W 30/12; G05D 1/00; G05D 1/02

(52) U.S. Cl. CPC B60W 30/12; G05D 1/0088; G05D 1/0212; B60W 2420/42; B60W 2550/12; B60W 2420/52; B60W 2422/00; B60W 2720/24; B60W 2420/403

(57) ABSTRACT

A control device for a vehicle comprising target running route setting part setting a target running route, a target running line setting part setting a target running line when running on a running lane on the target running route, a driving operation part automatically performing a driving operation of the vehicle so that the vehicle automatically runs along the target running line, a driving assistance part activating a driving assistance operation for avoiding crossing of a dividing line on the running lane when it is predicted that the vehicle will cross it or when it has crossed it, and an activation condition setting part configured to set an activation condition of the driving assistance operation based on the target running line or configuration of the road ahead of the host vehicle when a driving operation of the vehicle is automatically performed by the driving operation part.

### CROSS-REFERENCE TO RELATED APPLICATION

This application claims priority to Japanese Patent Application No. 2017-030206 filed with the Japan Patent Office on Feb. 21, 2017, the entire contents of which are incorporated into the present specification by reference.

### TECHNICAL FIELD

The present disclosure relates to a control device for a vehicle.

### BACKGROUND ART

JP2014-44744A discloses a conventional control device for a vehicle configured so as to enable a driving assistance operation to be performed alerting a driver when a vehicle is predicted to cross a dividing line on a running lane during manual driving or when it has actually crossed it.

### SUMMARY OF DISCLOSURE

However, the above-mentioned conventional control device for a vehicle was not configured for performing automated driving making a vehicle automatically run along a running line set inside a running lane when running along the running lane. For this reason, at the time of such automated driving, under what condition the driving assistance operation should be activated for keeping the vehicle from departing from a lane was not considered.

During automated driving, various running lines can be set inside a running lane depending on the road situation. For example, when running along a curve etc., to keep down lateral acceleration applied to a driver, sometimes an “out-in-out” running line is set as the running line inside the running lane. If doing this, when running inside the running lane, the vehicle will approach a dividing line on the running lane, so the driving assistance operation for inhibiting lane departure is liable to end up being activated. That is, a driving assistance operation for inhibiting lane departure is liable to end up being unnecessarily activated during automated driving.

The present disclosure was made taking note of this problem and has as its object to keep the driving assistance operation for inhibiting lane departure from ending up being unnecessarily activated during automated driving.

To solve the above problem, according to one aspect of the present disclosure, there is provided a control device for a vehicle for controlling a vehicle provided with a surrounding environment information acquiring device configured to acquire surrounding environment information relating to a state of a surrounding environment of a host vehicle and a host vehicle information acquiring device configured to acquire host vehicle information relating to a state of a host vehicle, the control device of a vehicle comprising a target running route setting part configured to set a target running route when making the vehicle run automatically based on the host vehicle information and map information stored in advance, a target running line setting part configured to set a target running line when running on a running lane on the target running route based on the surrounding environment information and the host vehicle information, a driving operation part configured to automatically perform a driving operation of the vehicle based on at least the surrounding environment information and the host vehicle information so that the vehicle automatically runs along the target running line, a driving assistance part configured to activate a driving assistance operation so as to alert a driver about or avoid crossing a dividing line on the running lane when it is predicted that the vehicle will cross it or when it has crossed it, and an activation condition setting part configured to set an activation condition of the driving assistance operation based on the target running line or configuration of the road ahead of the host vehicle when a driving operation of the vehicle is automatically performed by the driving operation part.

According to this aspect of the present disclosure, it is possible to keep a driving assistance operation for inhibiting lane departure from ending up being unnecessarily activated during automated driving.

### BRIEF DESCRIPTION OF DRAWINGS

FIG. 1 is a schematic view of the configuration of an automated driving system for a vehicle according to a first embodiment of the present disclosure.

FIG. 2 is a schematic view of the outside appearance of a host vehicle carrying an automated driving system according to the first embodiment of the present disclosure.

FIG. 3 is a schematic view of the inside appearance of a host vehicle carrying an automated driving system according to the first embodiment of the present disclosure.

FIG. 4 is a view for explaining one example of a method of calculating a dividing line distance X.

FIG. 5 is a view explaining a problem arising when a lane departure alert (LDA) function is permitted by a driver during automated driving.

FIG. 6 is a flow chart explaining control according to the first embodiment of the present disclosure during the automated driving mode.

FIG. 7 is a view explaining a problem when an actual running line ends up deviating from a target running line due to some sort of factor.

FIG. 8 is a flow chart explaining control according to a second embodiment of the present disclosure during an automated driving mode.

FIG. 9 is a view explaining an effect at consecutive curves when performing control according to the second embodiment of the present disclosure during an automated driving mode.

FIG. 10 is a flow chart explaining control according to a third embodiment of the present disclosure during an automated driving mode.

### DESCRIPTION OF EMBODIMENTS

Below, referring to the drawings, embodiments of the present disclosure will be explained in detail. Note that, in the following explanation, similar component elements will be assigned the same reference notations.

### First Embodiment

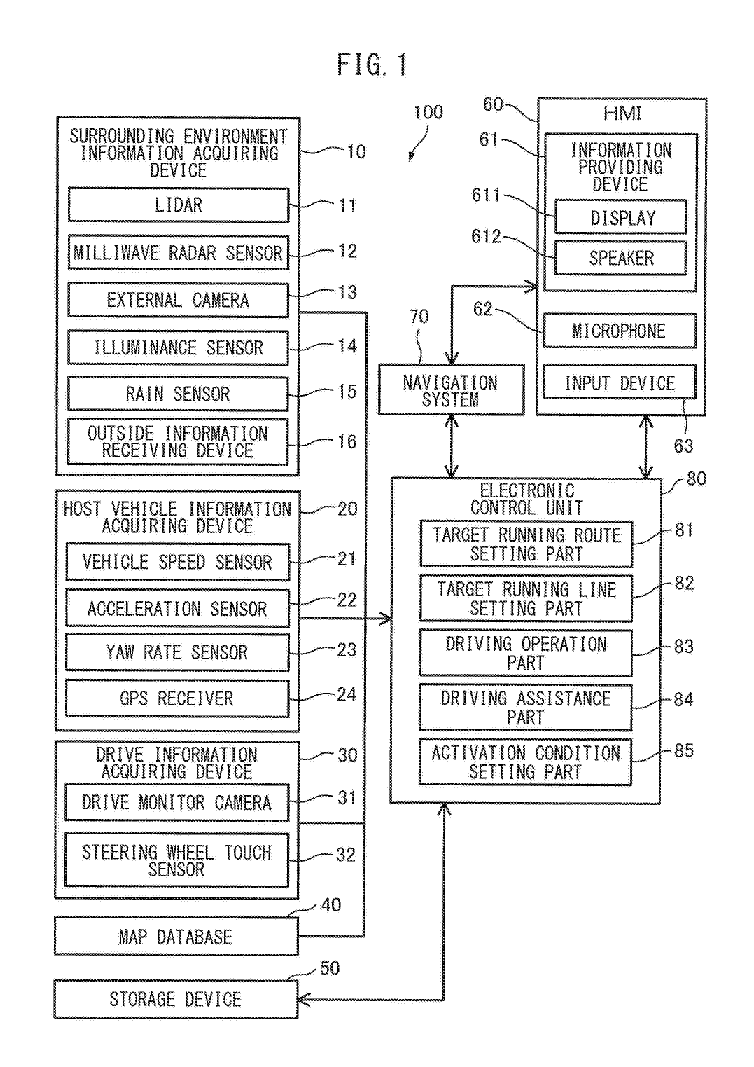

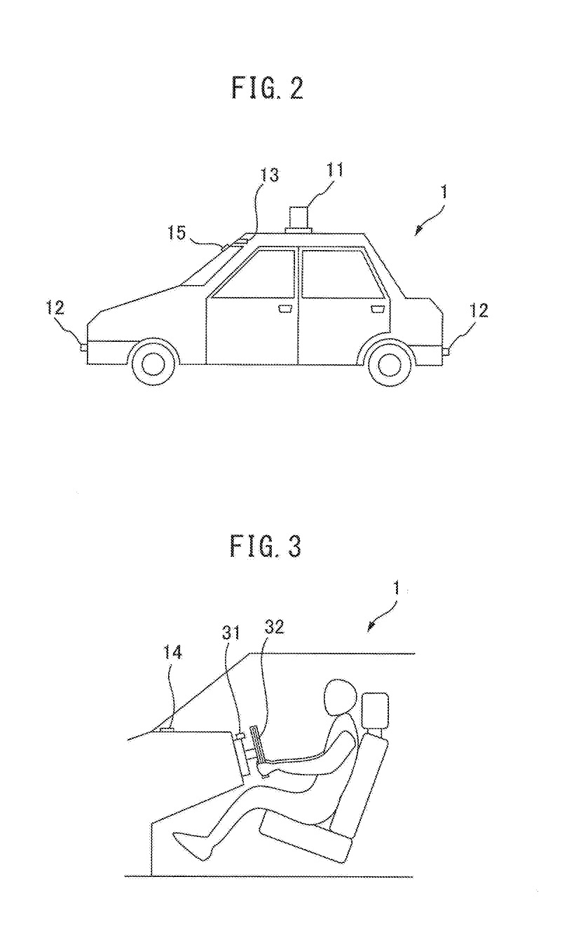

FIG. 1 is a schematic view of the configuration of an automated driving system 100 for a vehicle according to a first embodiment of the present disclosure. FIG. 2 is a schematic view of the outside appearance of a host vehicle 1 carrying the automated driving system 100 according to the present embodiment. FIG. 3 is a schematic view of the inside appearance of the host vehicle 1 carrying the automated driving system 100 according to the present embodiment.

As shown in FIG. 1, the automated driving system 100 according to the present embodiment is provided with a surrounding environment information acquiring device 10, a host vehicle information acquiring device 20, a driver information acquiring device 30, a map database 40, a storage device 50, a human-machine interface (below, referred to as an “HMI”) 60, a navigation system 70, and an electronic control unit 80.

The surrounding environment information acquiring device 10 is a device for acquiring information relating to obstacles in the surroundings of the host vehicle (for example, buildings, moving vehicles such as vehicles in front of it and in back of it on the road and oncoming vehicles, stopped vehicles, the curb, fallen objects, pedestrians, etc.) and the weather and other such surrounding environmental conditions of the host vehicle 1 (below, referred to as the “surrounding environment information”). As shown in FIG. 1 to FIG. 3, the surrounding environment information acquiring device 10 according to the present embodiment is provided with a LIDAR (laser imaging detection and ranging) device 11, milliwave radar sensors 12, an external camera 13, illuminance sensor 14, rain sensor 15, and outside information receiving device 16.

The LIDAR device 11 uses laser beams to detect the road and obstacles in the host vehicle surroundings. As shown in FIG. 2, in the present embodiment, the LIDAR device 11 is, for example, attached to the roof of the host vehicle 1. The LIDAR device 11 successively fires laser beams toward the overall surroundings of the host vehicle 1 and measures the distances to the road and host vehicle surroundings from the reflected light. Further, the LIDAR device 11 uses the results of measurement as the basis to generate 3D images of the road and obstacles in the overall surroundings of the host vehicle 1 and sends information of the generated 3D images to the electronic control unit 80.

Note that, the location of attachment of the LIDAR device 11 is not particularly limited so long as the LIDAR device 11 is attached at a location where the information necessary for generating a 3D image can be acquired. For example, the LIDAR device 11 may also be attached to the grilles or to the insides of the headlights or brake lights and other such lights of the host vehicle 1 or may be attached to parts of the body (frame) of the host vehicle 1.

The milliwave radar sensors 12 utilize electromagnetic waves to detect obstacles in the host vehicle surroundings at a farther distance than the LIDAR device 11. As shown in FIG. 2, in the present embodiment, the milliwave radar sensors 12, for example, are attached to the front bumper and rear bumper of the host vehicle 1. The milliwave radar sensors 12 emit electromagnetic waves to the surroundings of the host vehicle 1 (in the present embodiment, the front, rear, and sides of the host vehicle 1) and use the reflected waves to measure the distances to obstacles in the host vehicle surroundings and the relative speed with the obstacles. Further, the milliwave radar sensors 12 send the results of measurement as host vehicle surrounding information to the electronic control unit 80.

Note that, the locations of attachment of the milliwave radar sensors 12 are not particularly limited so long as the milliwave radar sensors 12 are attached at locations where the necessary host vehicle surrounding information can be acquired. For example, they may also be attached to the grilles or to the insides of the headlights or brake lights and other such lights of the host vehicle 1 or may be attached to parts of the body (frame) of the host vehicle 1.

The external camera 13 captures an image of the area in front of the host vehicle 1. As shown in FIG. 2, in the present embodiment, the external camera 13 is, for example, attached to the center part of the front of the roof of the host vehicle 1. The external camera 13 processes the captured image of the area in front of the host vehicle to detect information on obstacles in front of the host vehicle, the width of the lane of the road driven on and the road shape, road signs, white lines, the state of traffic lights, and other road information in the area in front of the host vehicle, the yaw angle (relative direction of vehicle with respect to lane driven on), the offset position of the vehicle from the center of the lane driven on, and other such driving information of the host vehicle X, rain or snow or fog and other such weather information of the host vehicle surroundings, etc. Further, the external camera 13 sends the detected image information to the electronic control unit 80.

Note that, the location of attachment of the external camera 13 is not particularly limited so long as a location able to capture an image of the area in front of the host vehicle 1. For example, the camera may also be attached to the top of the center part of the back surface of the front glass of the host vehicle.

The illuminance sensor 14 detects the illuminance in the host vehicle surroundings. As shown in FIG. 3, in the present embodiment, the illuminance sensor 14 is, for example, attached to the top surface of the instrument panel of the host vehicle. The illuminance sensor 14 sends the detected illuminance information of the host vehicle surroundings to the electronic control unit 80.

The rain sensor 15 detects the presence of rainfall and the amount of rainfall. As shown in FIG. 2, in the present embodiment, the rain sensor 15 is, for example, attached to the top of the center of the front surface of the front glass of the host vehicle 1. The rain sensor 15 fires light generated by a built-in light emitting diode toward the front surface of the front glass and measures the change in the reflected light at that time so as to defect the presence of rainfall, the amount of rainfall, and other rainfall information. Further, the rain sensor 15 sends the detected rainfall information to the electronic control unit 80.

The outside information receiving device 16, for example, receives congestion information, weather information (rain, snow, fog, wind speed, and other information), and other outside information road sent from a traffic information communication system center or other outside communication center. The outside information receiving device 16 sends the received outside information to the electronic control unit 80.

The host vehicle information acquiring device 20 is a device for acquiring a speed or acceleration, posture, and current position of the host vehicle 1 and other such information relating to the conditions of the host vehicle 1 (below, referred to as “host vehicle information”). As shown in FIG. 1, the host vehicle information acquiring device 20 according to the present embodiment is provided with a vehicle speed sensor 21, acceleration sensor 22, yaw rate sensor 23, and GPS receiver 24.

The vehicle speed sensor 21 is a sensor for detecting the speed of the host vehicle 1. The vehicle speed sensor 21 sends the detected vehicle speed information of the host vehicle 1 to the electronic control unit 80.

The acceleration sensor 22 is a sensor for detecting the acceleration of the host vehicle 1 at the time of accelerating or the time of braking. The acceleration sensor 22 sends the detected acceleration information of the host vehicle 1 to the electronic control unit 80.

The yaw rate sensor 23 is a sensor for detecting the posture of the host vehicle 1, more specifically for detecting the speed of change of the yaw angle at the time the host vehicle 1 turns, that is, the rotational angular speed (yaw rate) about the vertical axis of the host vehicle 1. The yaw rate sensor 23 sends the detected posture information of the host vehicle 1 to the electronic control unit 80.

The GPS receiver 24 receives signals from three or more GPS satellites to identify the longitude and latitude of the host vehicle 1 and detect the current position of the host vehicle 1. The GPS receiver 24 sends the detected current position information of the host vehicle 1 to the electronic control unit 80.

The driver information acquiring device 30 is a device for acquiring information relating to the condition of the driver of the host vehicle 1 (below, referred to as the “driver information”). As shown in FIG. 1 and FIG. 3, the drover information acquiring device 30 according to the present embodiment is provided with a driver monitor camera 31 and a steering wheel touch sensor 32.

The driver monitor camera 31 is attached to the top surface of the steering wheel column cover and captures an image of the appearance of the driver. The driver monitor camera 31 processes the captured image of the driver to detect information on the driver (direction of face of driver, degree of opening of eyes, etc.) and information on the appearance of the driver such as his posture. Further, the driver monitor camera 31 sends the detected information of the appearance of the driver to the electronic control unit 80.

The steering wheel touch sensor 32 is attached to the steering wheel. The steering wheel touch sensor 32 detects whether the driver is gripping the steering wheel and sends the detected information on the gripping of the steering wheel to the electronic control unit 80.

The map database 40 is a database relating to map information. This map database 40 is for example stored in a hard disk drive (HDD) mounted in the vehicle. The map information includes positional information on the roads, information on the road shapes (for example, curves or straight stretches, curvature of curves, etc.), positional information on the intersections and turn-off points, information on the road types, etc.

The storage device 50 stores a road map designed for automated driving. The automated driving use road map is prepared by the electronic control unit 80 based on the 3D image generated by the LIDAR device 11 and constantly or periodically updated by the electronic control unit 80.

The HMI 60 is an interface for input and output of information between the driver or vehicle passengers and the automated driving system 100. The HMI 60 according to the present embodiment is provided with an information providing device 61 for providing various types of information to the driver, a microphone 62 for recognizing speech of the driver, and a touch panel, operating buttons, or other input device 63 at which the driver performs input operations.

The information providing device 61 is provided with a display 611 for displaying text information or image information and a speaker 612 fox generating sound.

The navigation system 70 is a system for guiding the host vehicle 1 to a destination set by the driver through the HMI 60. The navigation system 70 computes the running route to the destination based on the current position information of the host vehicle 1 detected by the GPS receiver 24 and map information of the map database 40 and transmits information relating to the computed running route etc. as navigation information to the electronic control unit 80.

The electronic control unit 80 is a microcomputer provided with components connected with each other by a bidirectional bus such as a central processing unit (CPU), read only memory (ROM), random access memory (RAM), input port, and output port.

The electronic control unit 80 is provided with a target running route setting part 81, a target running line setting part 82, and a driving operation part 83 and is configured to perform automated driving masking the vehicle run by automatically performing driving operations relating to acceleration, steering, and braking when the driver switches from the manual driving mode (mode where driver performs driving operations relating to acceleration, steering, and braking) to automated driving mode.

The target running route setting part 81 sets the target running route of the vehicle during the automated driving mode. Specifically, the target running route setting part 81 sets the running route included in the navigation information as the target running route when the driver has set the destination in advance through the BMI SO, On the other hand, when the destination has not been set by the driver, the target running route setting part 81 sets the running route tor making the vehicle run along the direct road as the target running route based on the current position information of the host vehicle 1 and the map information of the map database 40.

The target running line setting part 82 sets the target running line for when running on the running lane on the target running route. Specifically, the target running line setting part 82 sets as the target running line a running line whereby the lateral acceleration applied to the driver becomes less than a predetermined upper limit acceleration when passing ever the road ahead of the host vehicle by a suitable speed corresponding to the road conditions (degree of congestion, road configuration, road surface conditions, etc.) based on information on obstacles ahead of the host vehicle (information on preceding vehicles, fallen objects, etc.), information on the road ahead of the host vehicle such as the width of the running lane and road configuration, and information on the speed of the host vehicle.

In the present embodiment, the target running line setting part 82 sets a running line by which the vehicle runs along the center of the running lane (below, referred to as the “reference running line”) as the target running line when, for example, the configuration of the road ahead of the host vehicle is straight, is a gentle curve, or otherwise where if is judged that the lateral acceleration applied to the driver will become less than a predetermined upper limit acceleration even if passing over the read ahead of the host vehicle by a suitable speed corresponding to the road conditions.

On the other hand, for example, when the configuration of the road ahead of the host vehicle is a sharp curve, if trying to pass along the center of the running lane along the curvature of the curve by a suitable speed corresponding to the current road conditions, the lateral acceleration will sometimes become the upper limit acceleration or more. Therefore, the target running line setting part 82, in such a case, does not set the reference line as the target running line, but sets a so-called “out-in-out” running line as the target running line so as to effectively utilize the width of the running lane to reduce lateral acceleration.

Further, the target running line setting part 82 sets as the target running line a running line deviating from the reference running line so as to avoid an obstacle if, for example, there is a fallen object or other obstacle on the road ahead of the host vehicle.

The driving operation part 83 automatically performs driving operations relating to acceleration, steering, and braking so that the vehicle runs along the target running line. Specifically, the driving operation part 83 controls the various types of control parts required for driving operations relating to acceleration, steering, and braking and automatically performs driving operations of the vehicle based on the surrounding environment information, host vehicle information, and, if necessary, driver information and other various information.

Further, the electronic control unit 80 is provided with a driving assistance part 84 in addition to the above-mentioned target running route setting part 81, target running line setting part 82, and driving operation part 83. It is configured to be able to automatically activate a driving assistance operation for which permission is obtained from the driver among the various types of driving assistance operations aimed at securing driver safety during the manual driving mode and automated driving mode. That is, the driving assistance part 84 automatically activates a driving assistance operation so long as being a driving assistance operation permitted by the driver by for example ON/OFF operation by the driver regardless of whether the driving mode is the manual driving mode or the automated driving mode.

As one such driving assistance operation, there is a “lane departure alert” function (below, referred to as the “LDA operation”) where when it is predicted that the vehicle will cross a dividing line on the running lane (white line, yellow line, etc.) or when it has actually crossed it, the driver is alerted to prompt the driver to perform a driving operation to avoid lane departure.

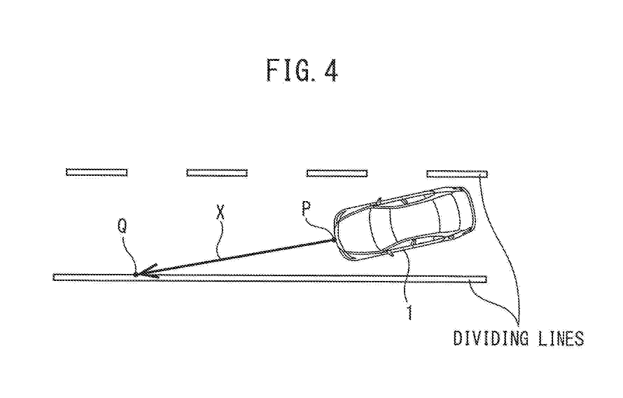

When the LDA operation is permitted by the driver, the driving assistance part 84 calculates a distance X from a front end of the vehicle to the dividing line positioned the nearest to it (below, referred to as the “dividing line distance”) and basically activates the LDA operation and alerts the driver when the dividing line distance X becomes a preset reference value XTH or less. In the present embodiment, when the LDA operation is permitted by the driver, the driving assistance part 84 first calculates the direction of advance of the host vehicle 1 from a yaw angle of the host vehicle detected by the external camera 13. Further, as shown in FIG. 4, the driving assistance part 84 defines the length of the line segment PQ, where the center of the front end of the vehicle is the point P and the point where a parallel line L extending from the point P and parallel to the direction of advance of the host vehicle 1 and a dividing line of the running lane detected by the external camera 13 intersect is the point Q, as the dividing line distance X.

Here, if configuring the electronic control unit 80 so that the driving operation part 83 and the driving assistance part 84 completely independently perform control, the following such, problem is liable to occur when the LDA operation is permitted by the driver as one type of driving assistance operation during automated driving.

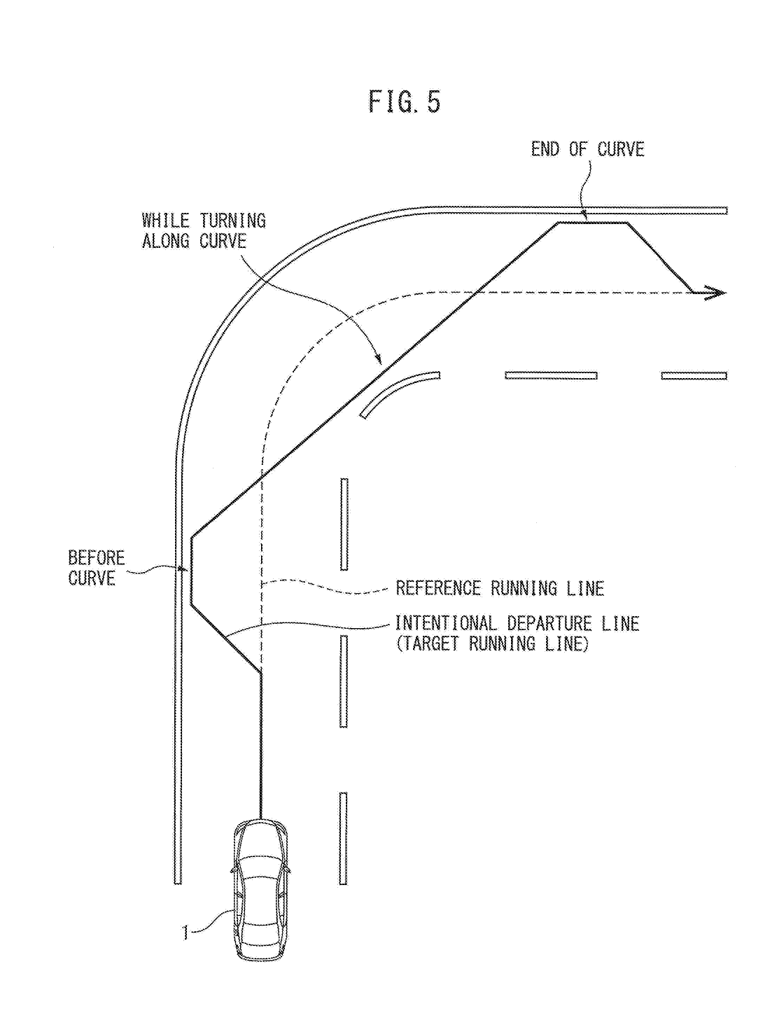

FIG. 5 is a view explaining the problem arising when the LDA operation is permitted by the driver during automated driving.

As shown in FIG. 5, during automated driving (when driving operations are being automatically performed by the driving operation part 83), sometimes an “out-in-out” running line is set as the target running line when running along a curve. This being so, before the curve, while turning along the curve, and at the end of the curve, the host vehicle 1 approaches a dividing line on the running lane, so the LDA operation is liable to be activated and the driver alerted. That is, the LDA operation is liable to be activated and the driver alerted despite running along the normal running line.

Further, as explained above, to avoid an obstacle on the road ahead of the host vehicle, sometimes a running line approaching a dividing line on the running lane is set as the target running line. In such a case as well, similarly, the LDA operation is liable to be activated and the driver to be alerted.

If, in this way, despite the normal running line being run along during automated driving, the LDA operation is activated, the driver is alerted, and the driver performs a driving operation to avoid lane departure, the operating mode is forcibly switched from the automated driving mode to the manual driving mode. That is, despite the fact that automated driving can be continued, the driver is unnecessarily alerted and the driver requested to switch to manual operation, so the convenience of automated driving is liable to be lessened.

Therefore, to keep the LDA operation from being unnecessarily activated despite the normal running line being run along during automated driving, the electronic control unit 80 according to the present embodiment is further provided with an activation condition setting part 85 setting an activation condition of the LDA operation based on the target running line when driving operations of the vehicle are being automatically performed by the driving operation part 83.

The activation condition setting part 65 sets the activation condition of the LDA operation so that when the reference running line is set as the target running line, the LDA operation is activated when the: dividing line distance X becomes a reference value XTH or less.

On the other hand, if an “cut-in-out” running line or other running line deviating from the reference running line and intentionally approaching a dividing line on the naming lane (below, referred to as an “intentional departure line”) is set as the target running line, the activation condition setting part 85 sets the activation condition of the LDA operation so that the LDA operation is activated when the dividing line distance X becomes a first predetermined value XTHlow or less shorter than the reference value XTH. That is, the activation condition setting part 85 sets the activation condition of the LDA operation so that activation of the LDA operation is suppressed when running along a curve, when avoiding an obstacle ahead on the road, or otherwise when an intentional departure line is set as the target running line. For this reason, it is possible to keep the LDA operation from unnecessarily ending up being activated.

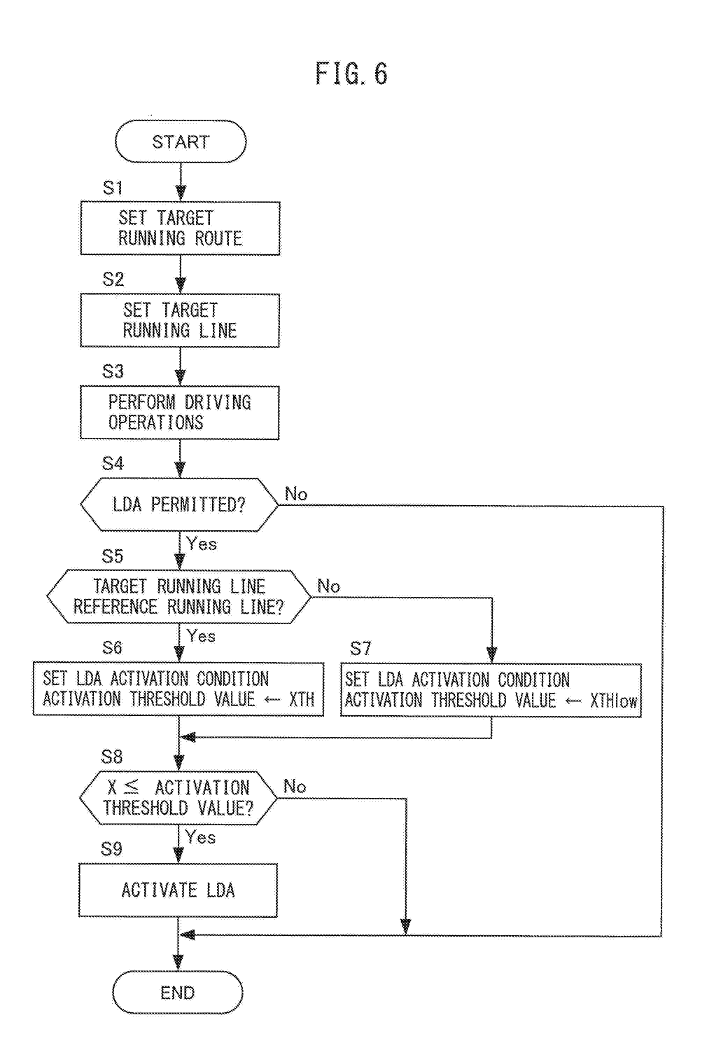

FIG. 6 is a flow chart explaining control according to the present embodiment during this automated driving mode. The electronic control unit 80 repeats the present routine by a predetermined computing period during the automated deriving mode.

At step S1, the electronic control unit 80 sets the target running route. In the present embodiment, the electronic control unit 80 sets a running route included in navigation information as the target running route if the navigation information contains the running route to that destination. On the other hand, the electronic control unit 80 sets the running route for making the vehicle run along the direct road as the target running route based on the current position information of the host vehicle 1 (host vehicle information) and map information of the map database 40 if the navigation information does not contain the running route to that destination.

At step S2, the electronic control unit 80 sets the target running line for when running along the running lane on the target running route. Specifically, the electronic control unit 80 sets the reference running line as the target running line based on information on obstacles ahead of the host vehicle, information on the road ahead of the host vehicle such as the width of the running lane or road configuration (surrounding environment information), and information on the speed of the host vehicle (host vehicle information) when, for example, the configuration of the road ahead of the host vehicle is straight, when it is a gentle curve, or otherwise when it is judged that even if passing over the road ahead of the host vehicle by a suitable speed corresponding to the configuration of the road, the lateral acceleration applied to the driver will become less than a predetermined upper limit acceleration.

On the other hand, the electronic control unit 80 sets an intentional departure line (“out-in-out” running line) as the target running line when, for example, the configuration of the road ahead of the host vehicle is a sharp curve or otherwise when it is judged that if passing over the road ahead of the host vehicle by a suitable speed corresponding to the configuration of the road, the lateral acceleration applied to the driver will become the predetermined upper limit acceleration or more. Further, the electronic control unit 80 sets an intentional departure line (running line for avoiding an obstacle) as the target running line based on the information on obstacles ahead of the host vehicle (surrounding environment information) when it is judged necessary to avoid an obstacle on the road ahead of the host vehicle.

At step S3, the electronic control unit 80 automatically performs driving operations of the vehicle based on the surrounding environment information, host vehicle information, and, if necessary, driver information and other various types of information so that the vehicle automatically runs along the target running line.

At step S4, the electronic control unit 80 judges if the LDA operation is permitted by the driver. The electronic control unit 80 proceeds to the processing of step S5 if the LDA operation is permitted by the driver. On the other hand, the electronic control unit 80 ends the current processing if the LDA operation is not permitted by the driver.

At step S5, the electronic control unit 80 judges if the target running line is the reference running line. The electronic control unit 80 proceeds to the processing of step S6 if the target running line is the reference running line. On the other hand, the electronic control unit 80 proceeds to the processing of step S7 if the target running line is an intentional departure line.

At step S6, the electronic control unit 80 sets the activation condition of the LDA operation so that the LDA operation is activated when a dividing line distance X becomes a reference value XTH or less. That is, the electronic control unit 80 sets an activation threshold value when activating the LDA operation to a reference value XTH.

At step S7, the electronic control unit 80 sets the activation condition of the LDA operation so that the LDA operation is activated when the dividing line distance X becomes a first predetermined value XTHlow or less shorter than the reference value XTH. That is, the electronic control unit 80 sets the activation threshold value for when activating the LDA operation to the first predetermined value XTHlow.

At step S8, the electronic control unit 80 judges if the dividing line distance X has become the activation threshold value or less. The electronic control unit 80 proceeds to the processing of step S9 if the dividing line distance X becomes the activation threshold value or less. On the other hand, the electronic control unit 80 ends the current processing if the dividing line distance X is larger than the activation threshold value.

At step S9, the electronic control unit 80 activates the LDA operation. In the present embodiment, the electronic control unit 80 alerts the driver by a sound, but the alert method is not limited to this. Further, at the time of activation of the LDA operation, in addition to the audio alert, a steering operation may also be automatically performed to avoid lane departure.

According to the present embodiment explained above, there is provided an electronic control unit 80 (control device) for controlling a vehicle provided with a surrounding environment information a enquiring device 10 configured to acquire surrounding environment information relating to a state of a surrounding environment of a host vehicle 1 and a host vehicle information acquiring device 20 configured to acquire host vehicle information relating to a state of the host vehicle 1, the control device of a vehicle comprising a target running route setting part 81 configured to set a target running route when making the vehicle run automatically based on the host vehicle information and map information stored in advance, a target running line setting part 82 configured to set a target running line when running on a running lane on the target running route based on the surrounding environment information and the host vehicle information, a driving operation part 83 configured to automatically perform a driving operation of the vehicle based on at least the surrounding environment information and the boat vehicle information so chat the vehicle automatically runs along the target running line, a driving assistance part 84 configured to assist driving so as to avoid crossing of a dividing line on the running lane when it is predicted that the vehicle will cross it or when it has crossed it, and an activation condition setting part 85 configured to set an activation condition of the driving assistance operation based on the target running line when a driving operation of the vehicle is automatically performed by the driving operation part 83.

In this way, when driving operations of the vehicle are being automatically performed by the driving operation part 83, it is possible to set the activation condition for a driving assistance operation based on the target running line and cooperatively control the driving operation part 83 and the driving assistance part 84 so as to keep the LDA operation from ending up being unnecessarily activated during automated driving.

In particular, in the present embodiment, the activation condition of the LDA operation is set so that when the target running line becomes an intentional departure line closer to a dividing line than the reference running line passing through the center of the running lane, activation of the LDA operation is suppressed. More particularly, the activation condition of the LDA operation is set so that when the target running line is set to the reference running line, the LDA operation is activated when the distance between the host vehicle 1 and a dividing line becomes a predetermined reference value XTH or less. Further, the activation condition of the LDA operation is set so that when the target running line is set to an intentional departure line closer to a dividing line than the reference running line, the LDA operation is activated when the distance between the host vehicle 1 and the dividing line becomes a first predetermined value XTHlow or less smaller than the reference value XTH.

For this reason, the LDA operation can be kept from ending up being unnecessarily activated when running along a curve, when avoiding an obstacle ahead on the road, or otherwise when an intentional departure line intentionally making the host vehicle 1 approach a dividing line on the running lane is set as the target running line. That is, it is possible to keep the LDA operation from being unnecessarily activated despite the normal running line being run along during automated driving.

### Second Embodiment

Next, a second embodiment of the present disclosure will be explained. The present embodiment differs from the first embodiment in the method of setting the activation condition of the LDA operation during automated driving. Below, this point of difference will be focused on for the explanation.

In the above-mentioned first embodiment, when an Intentional departure line was set as the target running line, the activation condition of the LDA operation was set so that the LDA operation was activated when the dividing line distance X became the first predetermined value XTHlow or less. However, if the actual running line ends up deviating from the target running line due to some factor or another, the following problem is liable to arise.

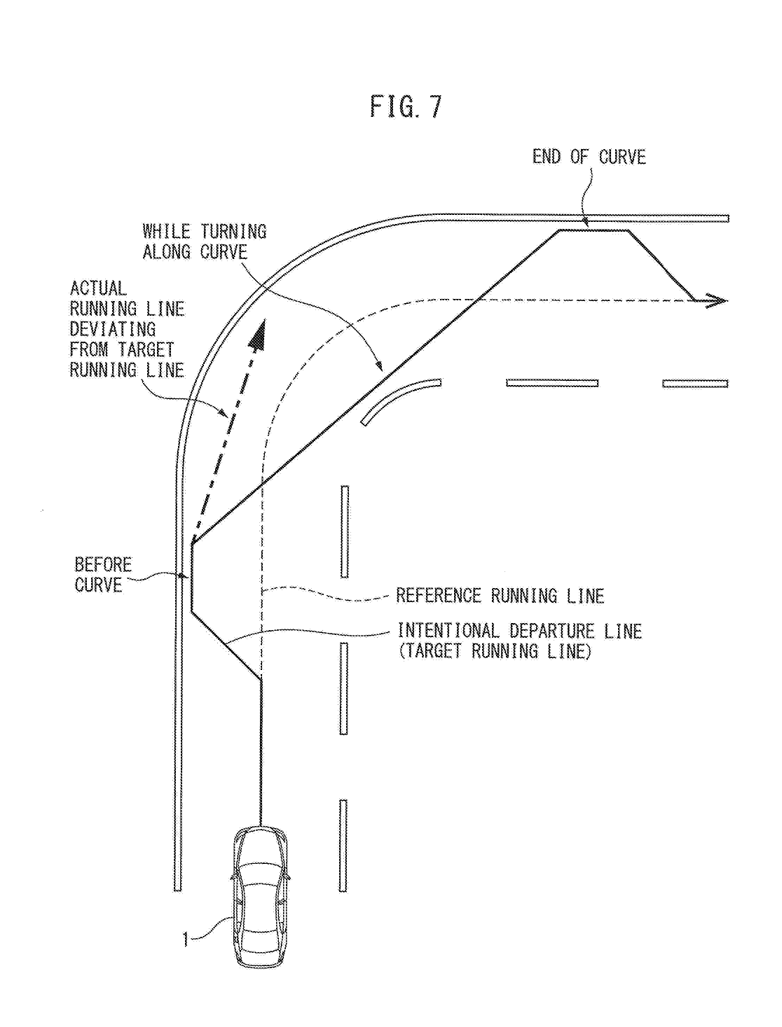

FIG. 7 is a view explaining a problem when the actual running line ends up deviating from the target running line due to some sort of reason.

In the example shown in FIG. 1, as shown by the solid line, an intentional departure line comprised of an “out-in-out” running line is set as the target running line. At this time, as shown by the one-dot chain line in FIG. 7, for example, while turning along a curve, tor example, the actual running line may deviate from the target running line and bulge out to the “out” side due to a problem in the LIDARs 11, external camera 13, measurement error of the various sensors, or other such sort of reason.

If, in this way, for example, when turning along a curve, the actual running line deviates from the target running line and bulges out to the “out” side (in thy example of FIG. 7, the left side), due to the normal running line not being able to be run along, it is desirable to activate the LDA operation and quickly alert the driver when the dividing line distance X (distance between vehicle and dividing line at “out” side) becomes the reference value XTH or less.

Further, this is not only limited to when turning along a curve. When right before a curve or at the end of the curve as well, the actual running line may deviate from the target running line and end up approaching the “in” sloe for son e sort of reason despite the fact that it should approach the “cut” side. In such a case as well, the normal running line cannot be run along, so it is desirable to activate the LDA and quickly alert the driver when the dividing line distance X (distance between vehicle and dividing line at “in” side) becomes the reference value XTH or less.

However, in the above-mentioned first embodiment, when an intentional departure line was set as the target running line, the activation condition of the LDA operation was set so that the LDA operation was activated at all times when the dividing line distance X became the first predetermined value XTHlow or less. For this reason, when the normal running line cannot be run along, the driver cannot be quickly alerted and the alert to the driver becomes delayed.

Therefore, in the present embodiment, when the dividing line distance X is the distance to the dividing line at the side from the reference running line where the intentional departure line is set, it can be judged that the normal running line can be run along, so the activation condition of the LDA operation is set so that the LDA operation is activated when the dividing line distance X becomes the first predetermined value XTHlow or less.

On the other hand, when the dividing line distance X is the distance to she dividing line at the side opposite to the side from the reference running line where the intentional departure line is set, it can be judged that the vehicle has deviated from the normal running line and is running along an abnormal running line, so the activation condition of the LDA operation is set so that the LDA operation is activated when the dividing line distance X becomes the reference value XTH or less.

Due to this, when an intentional departure line is set as the target running line, it is possible to keep the LDA operation from ending up being unnecessarily activated only when the vehicle is running along the normal running line.

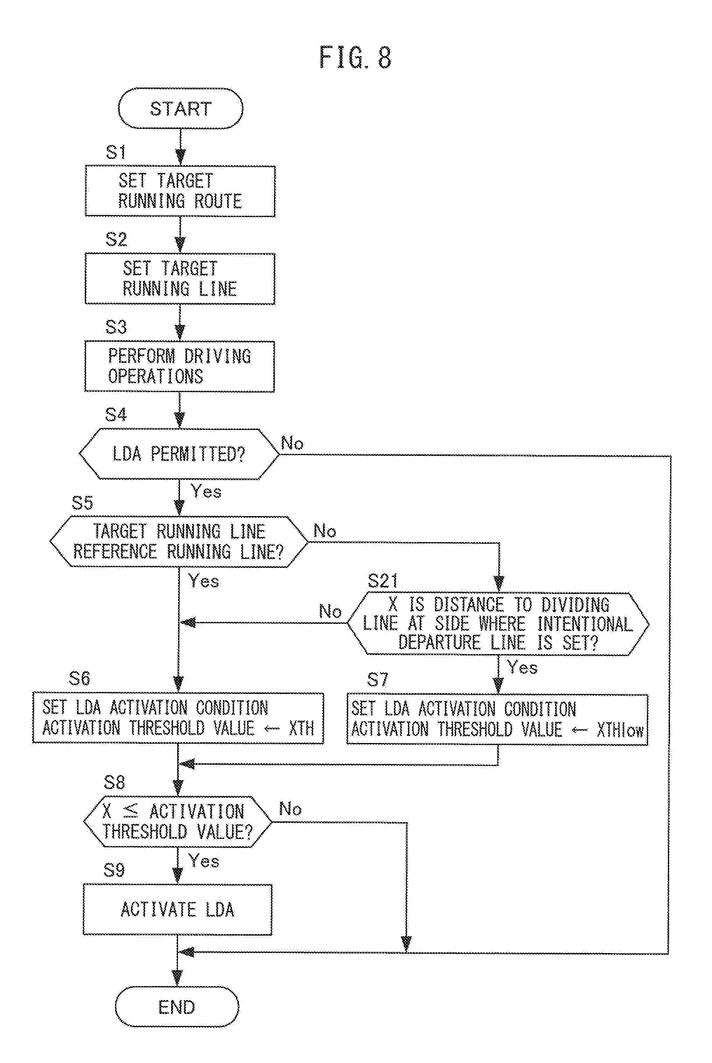

FIG. 8 is a flow chart explaining control according to the present embodiment during the automated driving mode. The electronic control unit 80 repeats the present routine by a predetermined computing period during the automated driving mode. Note that, in FIG. 8, the content of processing from step S1 to step S9 is similar to that of the first embodiment, so here the explanation will be omitted.

At step S21, the electronic control unit 80 judges, based on the information of the dividing line of the running lane detected by the external camera 13 etc., if the dividing line distance X is the distance to the dividing line at the side from the reference running line where the intentional departure line is set. The electronic control unit 80 proceeds to the processing of step S7 if the dividing line distance X is the distance to the dividing line at the side from the reference running line where the intentional departure line is set. On the other hand, the electronic control unit 80 proceeds to the processing of step S6 if the dividing line distance X is the distance to the dividing line at the opposite side to the side from the reference running line where the intentional departure line is set.

According to the present embodiment explained above, if the target running line is set to the reference running line running along the center of the running lane, the activation condition setting part 85 of the electronic control unit 80 sets the activation condition of the LDA operation so that the LDA operation is activated when the distance between the host vehicle 1 and a dividing line becomes a predetermined reference value XTH or less. On the other hand, if the target running line becomes an intentional departure line closer to a dividing line than the reference running line, the activation condition of the LDA operation is set so that the LDA operation is activated when the distance between the host vehicle 1 and the dividing line at the side from the reference running line where the departure line is set becomes a first predetermined value XTHlow or less smaller than the reference value XTH and when the distance between the host vehicle 1 and the dividing line at the opposite side to the side from the reference running line where the departure line is set becomes the reference value XTH or less.

Due to this, when an intentional departure line is set as the target running line during automated driving, it is possible to beep the LDA operation from ending up being unnecessarily activated when the host vehicle 1 is actually running along the target running line. On the other hand, when the host vehicle 1 is running along an abnormal running line deviating from the target running line, it is possible to activate the LDA operation as usual to quickly alert the driver so as to avoid lane departure.

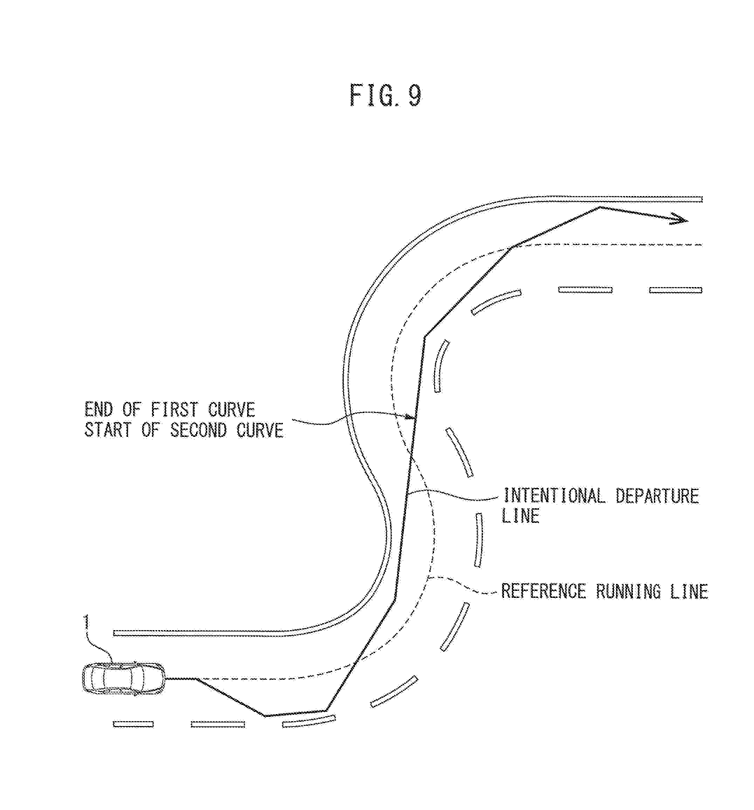

Further, by configuring the activation condition setting part 85 like in the present embodiment, for example, as shown, in FIG. 9, it is possible to suitably activate the LDA operation even in the case of consecutive curves or other cases where a complicated running line is set.

In FIG. 9, as an example of consecutive curves, a pattern of a left curve followed by a right curve is shown. In the case of consecutive curves, sometimes the end of the first curve (in example of FIG. 9, left curve) and the start of the next following second curve (in example of FIG. 9, right curve) are not clearly differentiated. In such a case, as shown, in FIG. 9, if running along the first curve by an “out-in-out” running line, at the start of the second curve, the vehicle will lean to the “in” side of the second curve. For this reason, sometimes setting a running line entering the second curve from the “in” side as is without making the vehicle lean to the “out” side before entering the second curve (in example of FIG. 9, without making it lean to the left side dividing line) enables lateral acceleration to be suppressed.

In this way, in the case of consecutive curves, sometimes a running line more complicated than the case of a single curve is set as the target running line (intentional departure line), but by configuring the activation condition setting part 85 like in the present embodiment, no matter what kind of running line is set as the target running line, including even the case of consecutive curves, the LDA operation can be activated as usual when the host vehicle 1 is running along an abnormal running line deviating from the target running line, so the driver can be quickly alerted to avoid lane departure. Further, it is possible to keep the LDA operation from ending up being unnecessarily activated when running along a normal running line.

### Third Embodiment

Next, a third embodiment of the present disclosure will be explained. The present embodiment differs from the first embodiment in the method of setting the activation condition of the LDA operation. Below, the point of difference will be focused on in the explanation.

In the above-mentioned first embodiment, when the reference running line was set as the target running line, the activation condition of the LDA operation was set so that the LDA operation was activated when the dividing line distance X became the reference value XTH or less. Further, when an intentional departure line was set as the target running line, the activation condition of the LDA operation was set so that the LDA operation was activated when the dividing line distance X became the first predetermined value XTHlow or less.

Here, when for example the curvature of a curve of the road ahead of the host vehicle is a predetermined value or more (that is, when the curve of the road ahead of the host vehicle is sharp) etc., it is predicted that an intentional departure line will be set as the target running line. Further, even if setting an intentional departure line as the target running line and easing the activation condition of the LDA operation, the LDA operation is liable to end up being activated.

Therefore, in the present embodiment, for example, the activation condition setting part 80 is configured to judge curvature of a curve on a road ahead of the host vehicle from the information on the configuration of the road ahead of the host vehicle included in the surrounding environment information, map information of the map database 40 (mainly information relating to the road configuration), etc. and set the activation condition of the LDA operation so that the LDA operation is not activated when the curvature of that curve is a predetermined value or more. That is, in the present embodiment, the activation condition setting part 85 is configured to set the activation condition of the LDA operation based on the target running line or configuration of the road ahead of the host vehicle.

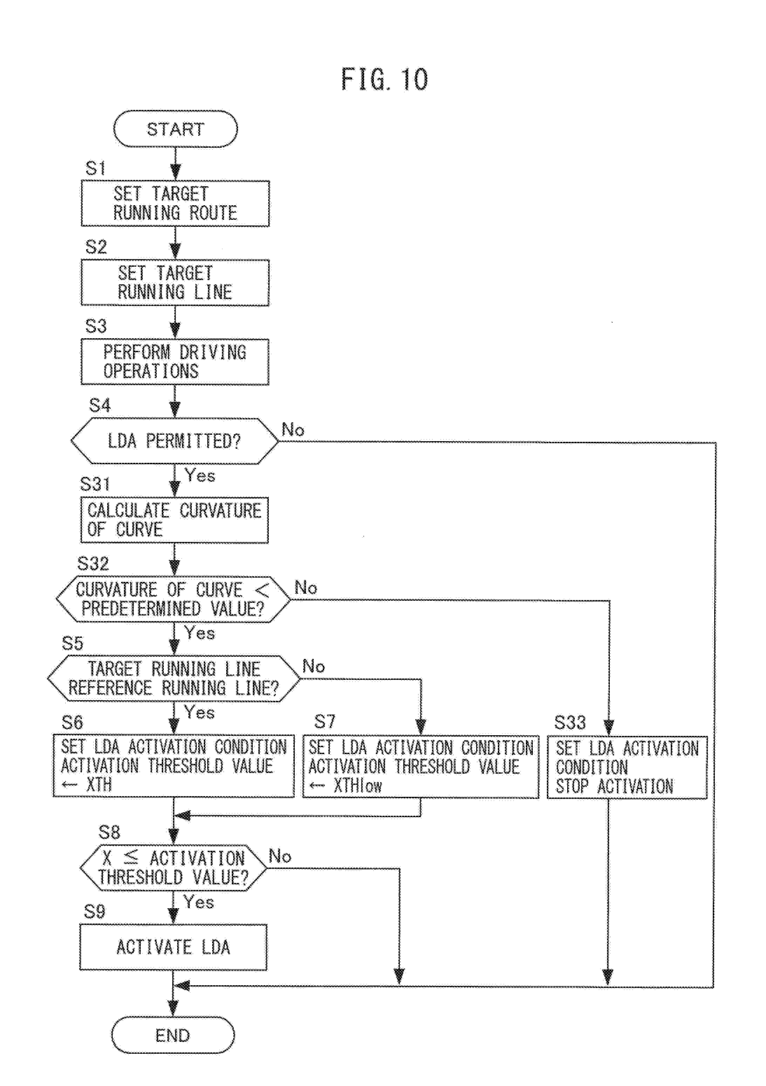

FIG. 10 is a flow chart explaining the control according to the present embodiment during the automated driving mode. The electronic control unit 80 repeatedly performs the present routine by a predetermined computing period during the automated driving mode. Note that in FIG. 10, the content of the processing from step S1 to step S9 is similar to the first embodiment, so the explanation will be omitted here.

At step S31, the electronic control unit 200 calculates the curvature of the curve of the road ahead of the host vehicle from the information on the configuration of the road ahead of the host vehicle contained in the surrounding environment information, map information of the map database 40 (mainly information relating to the road configuration) etc.

At step S32, the electronic control unit 200 judges if the curvature of the curve of the road ahead of the host vehicle is less than a predetermined value. The electronic control unit 200 proceeds to the processing of step S5 if the curvature of the curve of the road ahead of the host vehicle is less than the predetermined value. On the other hand, the electronic control unit 200 proceeds to the processing of step S33 if the curvature of the curve of the road ahead of the host vehicle is the predetermined value or more.

At step S33, the electronic control unit 200 sets the activation condition of the LDA operation so that the LDA operation is not activated.

According to the present embodiment explained above, the activation condition setting part 85 of the electronic control unit 80 is configured to set the activation condition of the LDA operation based on the target running line or configuration of the road ahead of the host vehicle when the driving operations of the vehicle are being automatically performed by the driving operation part 83. Specifically, the activation condition setting part 85 calculates the curvature of the curve of the road ahead of the host vehicle based on at least one of the surrounding environment information or the map information stored in advance and sets the activation condition of the LDA operation so that the LDA operation is net activated when the curvature of the curve is a predetermined value or more.

Due to this, it is possible to keep the driving assistance operation for inhibiting lane departure from ending up being unnecessarily activated during automated driving even more.

Note that, in the present embodiment, when the curvature of the curve of the road ahead of the host vehicle is less than a predetermined value, the activation condition of the LDA operation is set based on the target running line. However, more simply, it is also possible to set the activation condition of the LDA operation so that the LDA operation is not activated when the curvature of the curve of the road ahead of the host vehicle is a predetermined value or more and to not particularly set the activation condition of the LDA operation based on the target running line when the curvature of the curve of the road ahead of the host vehicle is less than the predetermined value, but have the LDA operation activate at all times when the dividing line distance X becomes the reference value XTH or less.

Above, embodiments of the present disclosure were explained, but the above embodiments only show some of the examples of applications of the present disclosure and are not meant to limit the technical scope of the present disclosure to the specific constitutions of the embodiments.

For example, in the first embodiment, when the target running line became an intentional departure line closer to a dividing line than the reference running lire, the activation condition of the LDA operation was set so that the LDA operation was activated when the distance between the vehicle and dividing line became a first predetermined value XTHlow or less smaller than the reference value XTH. As opposed to this, as the simplest method for suppressing unnecessary activation of the LDA operation, it is also possible to set the activation condition of the LDA operation so that the LDA operation is not activated when the target running line becomes an intentional departure line.

Further, in the above embodiments, when the LDA operation was permitted by the driver, the LDA operation was activated when the dividing line distance X became the activation threshold value or less, but it is also possible to calculate the predicted time until lane departure from the dividing line distance X and speed and compare this predicted time and a threshold value to activate the LDA operation.

Further, the above embodiments may be suitably freely combined.

1. A control device for a vehicle for controlling a vehicle provided with:
a surrounding environment information acquiring device configured to acquire surrounding environment information relating to a state of a surrounding environment of a host vehicle; and
a host vehicle information acquiring device configured to acquire host vehicle information relating to a state of the host vehicle,
the control device comprising:
a target running route setting part configured to set a target running route when making the vehicle run automatically based on the host vehicle information and map information stored in advance;
a target running line setting part configured to set a target running line when running on a running lane on the target running route based on the surrounding environment information and the host vehicle information;
a driving operation part configured to automatically perform a driving operation of the vehicle based on at least the surrounding environment information and the host vehicle information so that the vehicle automatically runs along the target running line;
a driving assistance part configured to activate a driving assistance operation so as to alert about or avoid crossing of a dividing line on the running lane when it is predicted that the vehicle will cross the dividing line or when the vehicle has crossed the dividing line; and
an activation condition setting part configured to set an activation condition of the driving assistance operation based on the target running line or configuration of the road ahead of the host vehicle when the driving operation of the vehicle is automatically performed by the driving operation part.

2. The control device for a vehicle according to claim 1, wherein
the activation condition setting part is configured to set the activation condition of the driving assistance operation so that activation of the driving assistance operation is suppressed when the target running line becomes an intentional departure line closer to the dividing line than a reference running line passing through the center of the running lane.

3. The control device for a vehicle according to claim 1, wherein
the activation condition setting part is configured to:
set the activation condition of the driving assistance operation so that the driving assistance operation is activated when a distance between the vehicle and the dividing line becomes a predetermined reference value or less if the target running line is set to a reference running line passing through the center of the running lane; and
set the activation condition of the driving assistance operation so that the driving assistance operation is activated when a distance between the vehicle and the dividing line becomes a first predetermined value or less smaller than the reference value if the running line becomes an intentional departure line closer to the dividing line than the reference running line.

4. The control device for a vehicle according to claim 1, wherein
the activation condition setting part is configured to:
set the activation condition of the driving assistance operation so that the driving assistance operation is activated when a distance between the vehicle and the dividing line becomes a predetermined reference value or less if the target running line is set to a reference running line passing through the center of the running lane; and
set the activation condition of the driving assistance operation so that the driving assistance operation is activated when a distance between the vehicle and the dividing line at the side from the reference running line where the departure line is set becomes a first predetermined value or less smaller than the reference value and when a distance between the vehicle and the dividing line at an opposite side to the side from the reference running line where the departure line is set becomes the reference value or less if the target running line becomes an intentional departure line closer to the dividing line than the reference running line.

5. The control device for a vehicle according to claim 1, wherein
the activation condition setting part is configured so as to set the activation condition of the driving assistance operation so that the driving assistance operation is not activated when the target running line becomes an intentional departure line closer to the dividing line than a reference running line passing through the center of the running lane.

6. The control device for a vehicle according to claim 1, wherein
the activation condition setting part is configured to calculate a curvature of a curve of the road ahead of the host vehicle based on at least one of the surrounding environment information or the map information stores in advance and to set the activation condition of the driving assistance operation so that the driving assistance operation is not activated when a curvature of the curve is a predetermined value or more.
